(19) United States
(12) Patent Application Publication
(10) Pub. No.: US 2007/0028970 A1
(43) Pub. Date: Feb. 8, 2007

(54) Public water system protection apparatus

(76) Inventor: John Joseph Proulx JR., Middlebury, CT (US)

Correspondence Address: LAW OFFICE OF MICHAEL A. BLAKE, 112 BROAD STREET, MILFORD, CT, 06460, US

(21) Appl. No.: 11/199,066

(22) Filed: Aug. 8, 2005

(51) Int. Cl. F16K 31/14

(52) U.S. Cl. 137/613

(57) ABSTRACT

The disclosed apparatus relates to a public water system protection apparatus comprising: a single unit. The single unit comprises: a stop valve; and a check valve in fluid communication with the stop valve. The apparatus is configurable to couple to a customer water line and to prevent back flow into a water main. A public water system protection system comprising: a water main in fluid communication with a public water system; a customer water line in fluid communication with the water main and in fluid communication with a customer location; a public water system protection apparatus coupled to the customer water line and in fluid communication with the water main and in fluid communication with the customer location, and where the public water system protection apparatus comprises: a single unit. The single unit comprises: a stop valve; a check valve in fluid communication with the stop valve; and wherein the public water system protection apparatus is configured to prevent back flow into a water main.

### TECHNICAL FIELD

The present invention is directed to a public water system protection apparatus, and in particular to an apparatus for backflow prevention into a public water system.

### BACKGROUND

Since the attacks on Sep. 11, 2001, security has been a major concern of Federal, State and local governments. One possible target, for those who wish to harm the citizens of various countries, is the water supply. Municipal and other large water systems provide water via a water main to individual residences, multi-family homes, and businesses. Many of these municipal and other larger water systems only provide a stop valve between the water main and each residence and/or business. The stop valve allows the entity supplying water to turn off the water to a particular residence or business. It has been theorized that a person with bad intent, could inject a toxin, poison or other hazardous material into the municipal water system from inside a residence or business by merely injecting a hazardous material at a pressure that is higher than the water main pressure, so that the hazardous material will “backflow” from the residence or business into water main, thereby contaminating the water system.

Many state and local governments are at their budgetary limits in trying to put into place security measures to prevent, or decrease the harm from a terrorist attack. Thus what is needed is a low-cost, easily installed device that will limit or prevent the injection of a foreign substance into a public water system.

### SUMMARY

The disclosed apparatus relates to a public water system protection apparatus comprising: a single unit. The single unit comprises: a stop valve; and a check valve in fluid communication with the stop valve. The apparatus is configurable to couple to a customer water line and to prevent back flow into a water main.

A public water system protection system comprising: a water main in fluid communication with a public water system; a customer water line in fluid communication with the water main and in fluid communication with a customer location; a public water system protection apparatus coupled to the customer water line and in fluid communication with the water main and in fluid communication with the customer location, and where the public water system protection apparatus comprises: a single unit. The single unit comprises: a stop valve; a check valve in fluid communication with the stop valve; and wherein the public water system protection apparatus is configured to prevent back flow into a water main.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic view of a prior art public water system;

FIG. 2 is a schematic view of an embodiment of the disclosed public water system protection apparatus; and

FIG. 3 is a cross sectional view of the disclosed public water system protection apparatus.

### DETAILED DESCRIPTION

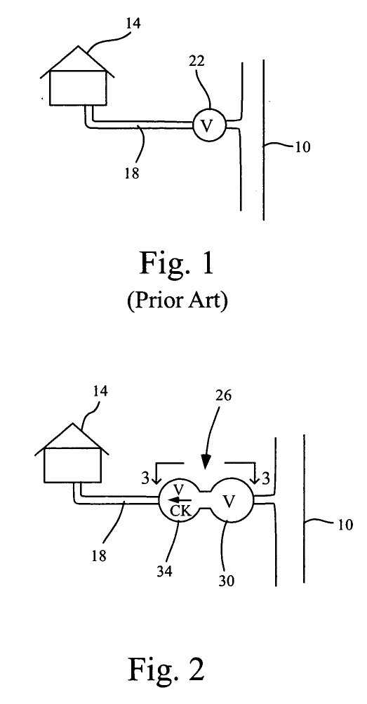

FIG. 1 shows a typical water main 10 in fluid communication with a customer location 14. The customer location 14 may be a residence, business, a multifamily residence, or any location where there is a consumer of water. A customer water line 18 connects the customer location 14 to the water main 10. A prior art stop valve 22 is located on the customer water line 18. The stop valve 22 is typically in an “on” position, allowing water from the water main 10 to travel to the customer location 14. The stop valve 22 may be turned to an “off” position if the customer has failed to pay the water bill, or if work needs to be done on the customer water line 18. The stop valve 22 is usually installed at the boundary of the private property line and a street line. The stop valve is typically buried underground at a depth below the frost line and the stop valve is typically operated by a gate wrench from above ground. The pressure of the water in the water main 10 is usually much greater than the pressure at the customer location 14. However, if the customer has access to equipment to allow him or her to pressurize the water in the piping at the customer location 14, such that the pressure at the customer location 14 is greater than the pressure at the water main 10, then the customer can inject a substance into the water pipes at customer location 14 and force that substance due to the greater “back pressure” into the water main 10.

FIG. 2 shows the disclosed public water system protection apparatus 26 in fluid communication with the water main 10 and in fluid communication with the customer location 14. The public water system protection apparatus 26 is a single unit fixture that comprises a stop valve 30 and a check valve 34. The check valve 34 is configured to only allow flow to travel from the water main 10 to the customer location 14 and to prevent flow from the customer location 14 back out to the water main 10. In a preferred embodiment, the public water system protection apparatus 26 is configured to easily replace the prior art stop valve 22, in that it may be sized the same as the valve 22, so that one can simply remove the stop valve 22 and replace it with the public water system protection apparatus 26. The public water system protection apparatus 26 will be connected to the customer water line 18.

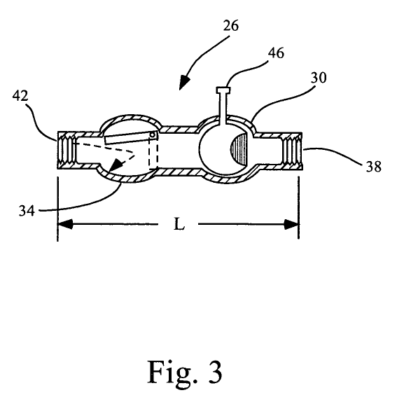

FIG. 3 shows a cross-sectional view of the public water system protection apparatus 26. The stop valve 30 portion of the apparatus 26 is shown to be a ball valve, however, any suitable stop valve may be used, including but not limited to: globe valves, butterfly valves, gate valves, plug valves, inverted key valves, cylindrical plug valves and needle valves. The stop valve 30 has a valve operator 46, which allows the water company or other suitable entity, to open or close the stop valve 30. The check valve 34 portion of the apparatus 26 is shown to be a swing check valve, however, any suitable type of check valve may be used so long as it restricts flow to one direction, such valves include, but are not limited to: double disc swing check valve, rubber flapper check valve, slanting disc check valve, silent check valve, foot check valve, slant disc check valve, flap check valve, spherical poppet check valve and control disc check valve. The apparatus 26 may have female iron pipe threads at the inflow end 38 and at the outflow end 42. In other embodiments, the inflow end 38 may have male iron pipe threads, the outflow end 42 may have male iron pipe threads, and both the inflow and outflow ends 38, 42 may have male iron pipe threads, female iron pipe threads, compression fitting connections or flare fitting connections or any combination of connections. The apparatus 26 may be made from cast, die cast or forged brass. In other embodiments, the apparatus 26 may be made from any suitable material, including, but not limited to: steel, iron, stainless steel, PVC, HDPE, and copper. The length L of the apparatus 26 is slightly longer than the length of a stop valve 22, thus the apparatus 26 can easily replace a stop valve 22. In other embodiments, the apparatus 26 may have flare connections located at the inflow end 38 and out flow end 42. In still other embodiments, the apparatus 26 may have compression connections located at the inflow end 38 and out flow end 42.

The disclosed public water system protection apparatus 26 has many advantages. It is a low cost single unit apparatus that can easily and inexpensively replace existing stop valves located between a water main 10 and a customer location 14. The public water system protection apparatus 26 also will prevent persons with bad intent from injecting a foreign substance via piping at a customer location 14 into the public water system.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

1. A public water system protection apparatus comprising:
a single unit comprising:
a stop valve;
a check valve in fluid communication with the stop valve; and
wherein the apparatus is configurable to couple underground at a depth below the frost line to a customer water line and to prevent back flow into a water main.

2. The public water system protection apparatus of claim 1, wherein the apparatus is configured to replace a stop valve already in place on a customer water line.

3. The public water system protection apparatus of claim 1, wherein the apparatus is approximately the same length of a stop valve the apparatus is configured to replace.

4. The public water system protection apparatus of claim 1, wherein the apparatus is made from a material selected from the group consisting of cast brass, forged brass, steel, iron, stainless steel, PVC, HDPE, and copper.

5. The public water system protection apparatus of claim 1, wherein the stop valve is stop valve selected from the group consisting of a ball valve, a gate valve, a globe valve, a butterfly valve, a plug valve, an inverted key valve, a cylindrical plug valve and a needle valve.

6. The public water system protection apparatus of claim 1, wherein the check valve is check valve selected from the group consisting of a swing check valve, a double disc swing check valve, a rubber flapper check valve, a slanting disc check valve, a silent check valve, a foot check valve, a slant disc check valve, a flap check valve, a spherical poppet check valve, and a control disc check valve.

7. The apparatus of claim 1, wherein the inflow end and the out flow end both comprise female iron pipe threads.

8. The apparatus of claim 1, wherein the inflow end and the out flow end both comprise male iron pipe threads.

9. The apparatus of claim 1, wherein the inflow end comprises a male iron pipe thread and the out flow end comprises a female iron pipe thread.

10. The apparatus of claim 1, wherein the inflow end comprises a female iron pipe thread and the out flow end comprises a male iron pipe thread.

11. The apparatus of claim 1, wherein the inflow end comprises a flare connection and the out flow end comprises a flare connection.

12. The apparatus of claim 1, wherein the inflow end comprises a compression connection and the out flow end comprises a compression connection.

13. A public water system protection system comprising:
a water main in fluid communication with a public water system;
a customer water line in fluid communication with the water main and in fluid communication with a customer location;
a public water system protection apparatus coupled underground at a depth below the frost line to the customer water line and in fluid communication with the water main and in fluid communication with the customer location;
wherein the public water system protection apparatus comprises:
single unit comprising:
a stop valve;
a check valve in fluid communication with the stop valve; and
wherein the public water system protection apparatus is configured to prevent back flow into a water main.
